(19) United States
(12) Patent Application Publication
(10) Pub. No.: US 2005/0015327 A1
(43) Pub. Date: Jan. 20, 2005

(54) Method of trading through a net

(76) Inventors: Yuval Eshet, Kfar Vradim (IL); Nir Schwager, Kfar Vradim (IL); Itzik Sansino, Kfar Vradim (IL)

Correspondence Address: Angenehm Law Firm. Ltd., P.O. Box 48755, Coon Rapids, MN, 55448-0755, US

(21) Appl. No.: 10/889,606

(22) Filed: Jul. 12, 2004

Related U.S. Application Data
(60) Provisional application No. 60/487,559, filed on Jul. 15, 2003.

(51) Int. Cl. G06F 17/60

(52) U.S. Cl. 705/37; 705/40

(57) ABSTRACT

The present invention provides a unique trading method that is presented to a plurality of users through a media such as Internet, TV, telephone networks etc. According to the new trading method, plurality of auctions, in which items are being sold, is offered to the users, wherein a target price is provided for each of the auctions. Bids are being collected from the users and payment for each bid is performed. The system then offers refunds to the users for their payment. Each to auction is closed and a single winning bid for each one of the auctions is announced, The payment is preferably refunded through coupons. The winning bid is chosen by discarding identical bids, comparing the remaining bids to the target price, and selecting a bid that is equal to, or closest to, the target price.

The present invention relates to a provisional patent application submitted to the United States Patent and Trademark Office on the 15 of Jul. 2003 and was given a Ser. No. 60/487,559.

### FIELD OF THE INVENTION

The present invention relates to auction trading. More particularly, the present invention relates to a method of trading using tenders submitted via different types of media such as the Internet, TV, cellular phone networks, telephone networks, newspapers & magazines.

### BACKGROUND OF THE INVENTION

Auctioning is rapidly becoming a mainstream method for transacting business-to-consumer (B2C) and person-to-person (P2P) trading of everyday goods and services, such as: consumer electronics, cars, vacation packages and much more. Existing auctioning methods and their implementations, however, suffer from a number of drawbacks that limit their attractiveness to consumers. Firstly, in order to hedge a seller's risk, some auctioning methods permit sellers to specify an auction's reserve price. When a reserve price is specified, an auction will not clear unless a bid exist such that it meets, or exceeds, this price. By its very nature the reserve price is hidden from bidders and is set at a level that guarantees the seller a profit. Studies have shown that bidders tend to become frustrated with reserve prices, particularly when these are perceived to be too high. Secondly, auctions do not limit the number of bids they allow, and usually will only accept bids that exceed the current highest bid. Moreover, even when a specific date is given as an auction's closing date, that auction may be extended if the reserve price has not been met, or bids have arrived in the last few moments of the allotted time frame. Thus, all throughout an auction, bidders have no concrete measure of the extent of competition that they face from other bidders. Their only benchmark for assessing their competitive position is price signaling. Even if they hold a winning bid they may become frustrated when they learn an auction did not close when they expected it to; either because it has not met the reserve price or because a bid was received in the last few seconds. To make matters worse, unethical sellers will sometimes bid up their own auctions by submitting factitious bids, especially if they sense that an auction might clear with a price that is lower than what they perceive as a “fair” price. In conclusion, and especially when it comes to hard-to-find or popular items, the above mentioned factors result in consumer price competition, which tends to drive up the clearing price of auctions and thus significantly reduce the likelihood that items will sell for prices substantially below market values. In fact, some empirical studies suggest that certain items, readily available Is through other retail channels, may sell for a premium at auctions.

### SUMMARY OF THE INVENTION

The trading method, which is the subject of the present invention, is a novel and unique auctioning method. In accordance with this method an item placed on auction—be it a product or service—is offered for a target price that may be substantially lower than the item's fair market value. In addition, an upper bound on the number of bids to be accepted is predetermined, which effectively puts a lower bound on a bid's likelihood of winning. Placing a bid may require paying a handling fee. When such payment occurs it will be refunded in the form of an entitlement of some Sorts having a monetary value substantially similar the handling fee. When the auction closes—usually upon reaching the predetermined bid quota—all duplicate (identical) bids are eliminated. Out of the remaining, unique, bids the bid closest to the target price is selected as the winning bid. Potentially, the winning bid is equal, or very close to the auction's target price. Thus an auction may clear at a price substantially lower then the market value of the item being sold.

It is therefore provided in accordance with a preferred embodiment of the present invention a trading method provided through a media to a plurality of users, said trading method comprising the following steps:
offering a plurality of auctions wherein in each of the auctions an item is being sold through the media, and wherein a target price is provided for each of said plurality of auctions;
collecting bids from the plurality of users wherein payment for each bid is performed by the plurality of users;
offering refunds to said plurality of users for said payment;
closing each one of said plurality of auctions;
choosing a single winning bid for each one of said plurality of auctions.

Furthermore, in accordance with another preferred embodiment of the present invention, the media is a computer network.

Furthermore, in accordance with another preferred embodiment of the present invention, verification of payment is performed.

Furthermore, in accordance with another preferred embodiment of the present invention, said refunds are offered in the form of at least one coupon having a face value substantially similar to said payment.

Furthermore, in accordance with another preferred embodiment of the present invention, said at least one coupon is printed by the plurality of users.

Furthermore, in accordance with another preferred embodiment of the present invention, choosing the winning bid comprises:
discarding identical bids;
comparing remaining bids to said target price
selecting a bid that is equal to, or closest to, said target price.

Furthermore, in accordance with another preferred embodiment of the present invention, the method further provides a predetermined upper bound on the total number of said bids.

Additionally, in accordance with another preferred embodiment of the present invention, several of said plurality of auctions are grouped in a group and the group itself is offered as an item.

### BRIEF DESCRIPTION OF THE FIGURES

In order to better understand the present invention and appreciate its practical applications, the following Figures are attached and referenced herein. Like components are denoted by like reference numerals.

It should be noted that the figures are given as examples and preferred embodiments only and in no way limit the scope of the present invention as defined in the appending Description and Claims.

FIG. 1 illustrates a block diagram of the method for trading in accordance with a preferred embodiment of the present invention.

FIG. 2 illustrates a block diagram of a buyer's actions in accordance with a preferred embodiment of the present invention.

### DETAILED DESCRIPTION OF THE PRESENT INVENTION

In the following detailed description of the preferred embodiments, reference is made to the accompanying drawings, which form a part hereof, and within which are shown by way of illustration specific embodiments by which the invention may be practiced. It is to be understood that other embodiments may be utilized and structural changes may be made without departing from the scope of the invention.

In the following text, the phrases “potential buyer”; “user”; “buyer”; “bidder”; or “participant” are used arbitrarily and all are intended to denote a person participating in the auction, an entity such as a company, or a group of people participating in an auction.

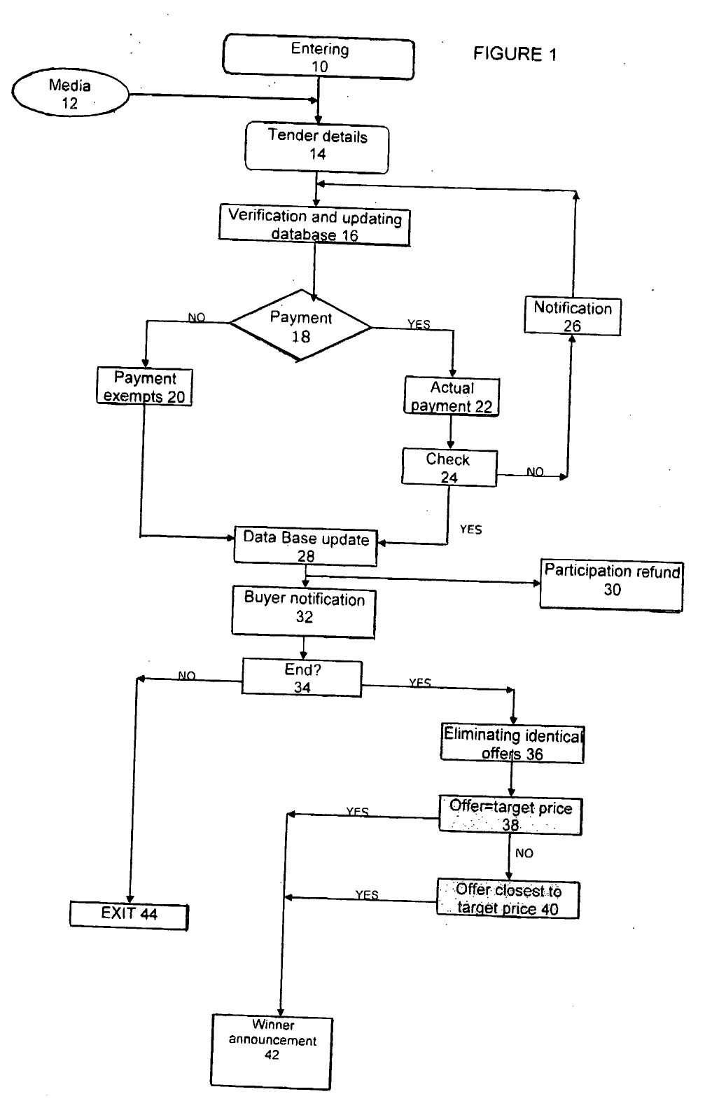

Reference is made to FIG. 1, illustrating a method of trading in accordance with a preferred embodiment of the present invention. Items on auction are posted on a home page, or promoted using advertisements 10 appearing in other media channels 12. In a preferred manner, a potential buyer enters an auction site of the present invention through a network such as the Internet. The potential buyer enters homepage 10 that presents a variety of items currently on auction through a media 12, preferably the Internet. The terms of each auction are disclosed 14, including: the particular item on sale, the target price, the upper bound on the number of bids and the handling fee. The buyer then selects a specific auction in which she wants to participate. That preferably brings up a more detailed description of that particular auction.

Placing a bid involves updating the database 16, offering a purchase price 18, and—unless an exemption exists 20—paying the posted handling fee 22. To secure payment, the user must provide a method of payment, for example, a credit card. Payment information is validated by the system 24. If the system detects a problem with the payment, the user is notified 26 and can update the payment details.

If the bid passes validation, the user is presented with a choice of free coupons, which are being offered by various commercial entities affiliated with the auction site. She may then choose coupons (one, or more) having a total face value similar to the handling fee for that particular auction. In effect, these coupons serve to refund the handling fee 30. Furthermore, refund is not contingent on the bid being the winning bid—a fact that can be ascertained only after the auction closes, as described herein below—but is allotted immediately after the bid has been accepted by the system. This refund mechanism is a unique and novel business model intended at raising overall trading volume by increasing both the conversation rate from potential to actual bidders and the number of tenders per individual bidder. This is accomplished by lowering a bid's perceived transaction cost, thus increasing its perceived value. In addition, since it creates a novel and highly targeted marketing channel for the coupon providers, this mechanism presents the site's operator with the opportunity for additional revenue streams, with potentially above normal returns. These could come in the form of advertising fees, revenue sharing schemes, etc.

All bids passing validation are recorded by the system 28 and the bidder is notified 32.

The system will not accept more than the predetermined number of bids.

When an auction closes 34, which could be the result of reaching the predetermined number bids, the system decides the winning bid. As described herein before, the winning bid is determined by eliminating all duplicated bids 36, that is, bids for which their exists another bid having the same value, then choosing the bid that equals the target price 38 or the bid that is closest to the predetermined target price 40. Once the winning bid has been determined, the system announces it 42.

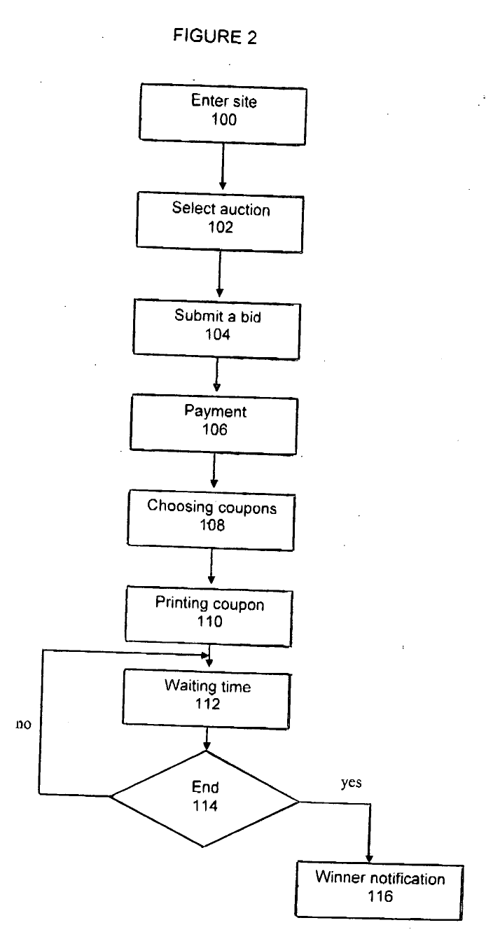

Reference is now made to FIG. 2 illustrating a block diagram of a buyer's actions in accordance with a preferred embodiment of the present invention. A potential buyer enters a web site 100 in which a variety of items is presented in an auction and can browse or search a list of open auctions. Each listing presents general information about an auction; the item being auctioned, the auction's terms, advertising materials, etc. The user may select a specific auction and view a more detailed description of the item being auctioned 102. If she so desires, the user can choose to submit a bid for a particular auction 104, Actual bidding is accomplished by submitting a tender that includes a bid price and the user's preferred method of payment 106. If the bid is accepted, the system offers the user refund in the form of coupons 108 as described herein before.

The user then prints the coupons 110 she selected.

The user then waits for the auction to close 112. As mentioned herein before, when the auction closes 114 the system determines the winning bid and announces it. It then notifies the winner, that is, the user that submitted the winning bid 116.

Another novel element of the trading method in accordance with a preferred embodiment of the present invention is the auctioning of a proxy item—a virtual item that represents a selection, or group, of concrete items. This type of auctioning is referred as a Proxy Auction. Which concrete items are included in a proxy auction may be subject to some selection criteria. Furthermore, the selection can be fixed or changed over time until the auction closes. In any case, a bid must be made against a particular concrete item. That is, out of the selection of concrete items, a bid must identify a single item and offer a purchase price for it. When the auction closes, the procedure for selecting the winning bid is the same as the procedure for selecting the winning bid in a single item auction, as describe herein before. The purpose of proxy auctions is to increase the attractiveness of auctions to potential buyers by letting each buyer decide on the item she prefers to win if her bid is the winning bid.

It should be clear that the description of the embodiments and attached Figures set forth in this specification serves only for a better understanding of the invention, without limiting its scope as covered by the following Claims.

It should also be clear that a person skilled in the art, after reading the present specification can make adjustments or amendments to the attached Figures and above described embodiments that would still be covered by the following Claims.

1. A trading method provided through a media to a plurality of users, said trading method comprising the following steps:
offering a plurality of auctions wherein in each of the auctions an item is being sold through the media, and wherein a target price is provided for each of said plurality of auctions;
collecting bids from the plurality of users wherein payment for each bid is performed by the plurality of users;
offering refunds to said plurality of users for said payment;
closing each one of said plurality of auctions;
choosing a single winning bid for each one of said plurality of auctions.

2. The trading method as claimed in claim 1, wherein the media is a computer network.

3. The trading method as claimed in claim 1, wherein verification of payment is performed.

4. The trading method as claimed in claim 1, wherein said refunds are offered in the form of at least one coupon having a face value substantially similar to said payment;

5. The trading method as claimed in claim 4, wherein said at least one coupon is printed by the plurality of users.

6. The trading method as claimed in claim 1, wherein choosing the winning bid comprises:
discarding identical bids;
comparing remaining bids to said target price selecting a bid that is equal to, or closest to, said target price.

7. The trading method as claimed in claim 1, further providing a predetermined upper bound on the total number of said bids.

8. The trading method as claimed in claim 1, wherein several of said plurality of auctions are grouped in a group and the group itself is offered as an item.
